(19) United States
(12) Patent Application Publication
(10) Pub. No.: US 2011/0267187 A1
(43) Pub. Date: Nov. 3, 2011

(54) SPORTS INSIGNIA BRAKELIGHT

(76) Inventor: STEVEN SWAN, Woodford, VA (US)

(21) Appl. No.: 12/772,308

(22) Filed: May 3, 2010

(51) Int. Cl. B60Q 1/44; G09F 13/00

(52) U.S. Cl. 340/467; 40/541

(57) ABSTRACT

The present invention includes an illuminated sports insignia for a vehicle comprising: a sports insignia; a body portion, where said body portion is behind the sports insignia; a bulb within the body portion; and a plug extending from the body portion, where said plug provides a means to connect to a trailer hitch receptacle. In one particular embodiment, the illuminated sports insignia includes an oval shape. Alternatively, the illuminated sports insignia may include a rectangular, a square or an octagon shape. The illuminated sports insignia may be synced with the brake lights of the vehicle.

### BACKGROUND OF THE INVENTION

1. Field of Invention

The present invention provides an illuminated sports insignia that provides a decorative means to show fan loyalty on a vehicle.

2. Description of Related Art

Vehicle signal lights are used to provide a signal of a vehicle's intention. Most of the signal lights relate to braking actions or turning intentions that are signaled in the rear of the vehicle to alert any vehicles that may be following the subject vehicle of its intention to brake or initiate a turn. Normally, the rear of a vehicle includes a row of brake lights, turn signals and a high-mounted brake light. The lights for braking are red and turn signals have a bright yellow color. Upon depressing of the vehicle's brakes the brake lights are illuminated to provide a signal of the vehicle's intention of slowing down or braking

Some systems have been developed to provide further communications to other vehicles based upon the conditions or actions of a driver of a vehicle. Such a communications device is disclosed in U.S. Pat. No. 5,905,434, which discloses a remote-control unit installed in the interior of a vehicle and a display unit located on the exterior of the vehicle where the exterior display unit displays a message based upon the input provided by the driver in the vehicle. The message is displayed in a banner-type manner and may include a variety of phrases as desired by the user thereof.

It would be advantageous to have an illumination device that includes a sports insignia of a particular sports team for illumination in coordination with the braking of a vehicle. The sports insignia illumination may be provided at a rear location of a vehicle that illuminates upon application of the vehicle's brakes.

### SUMMARY OF THE INVENTION

The present invention includes an illuminated sports insignia for a vehicle comprising: a sports insignia; a body portion, where said body portion is behind the sports insignia; a bulb within the body portion; and a plug extending from the body portion, where said plug provides a means to connect to a trailer hitch receptacle. In one particular embodiment, the illuminated sports insignia includes an oval shape. Alternatively, the illuminated sports insignia may include a rectangular, a square or an octagon shape. The illuminated sports insignia may be synced with the brake lights of the vehicle.

### BRIEF DESCRIPTION OF DRAWINGS

FIG. 1 depicts a front view of the sports insignia light according to the present invention.

FIG. 2 provides a view of the sports insignia light according to the present invention.

### DETAILED DESCRIPTION

The present invention relates to a sports insignia light that is mounted on the rear of a vehicle and is wired to work in conjunction with the application of the vehicle's brakes similar to the vehicle's brake lights. The sports insignia light according to the present invention applies a means to exhibit a sports team's insignia or name and therefore exhibit the user's loyalty or preference to a particular sporting team. The use of the sports insignia light provides fans the opportunity to show support for their favorite sports team. The sports insignia light is installed on any vehicle that includes a trailer receptacle for the input of the electrical wiring to the sports insignia light. The sports insignia light uses the trailer receptacle so that it is placed in sync with the brake lights of the vehicle.

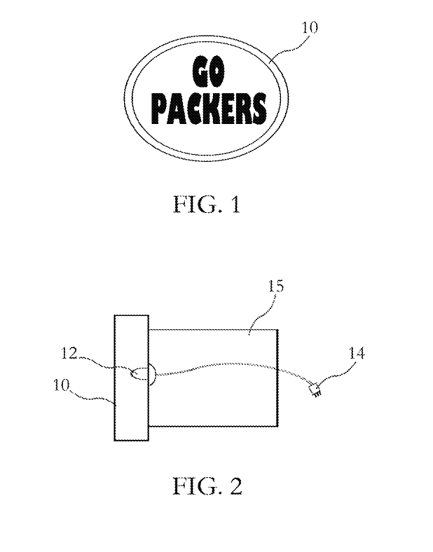

In reference to FIG. 1, a Sports Insignia Light 10 is depicted. In one particular embodiment, the sports insignia light is an oval-shaped light that is about 5 inches in diameter. The Insignia Light 10 includes a Plug 14, shown in FIG. 2, which connects to the trailer receptacle to provide power to the light and sync the light with the brake lights of the vehicle. The Sport Insignia Light 10 includes a faceplate that includes the insignia design for the desired sport team. The faceplate may be removed and interchanged with other faceplates that may depict a different sports team or insignia design and thus provides the user with versatility while using the Light 10.

A side view of the insignia light is depicted in FIG. 2 where a Bulb 12 is provided behind the sports insignia in order to illuminate the insignia during use. A Body Portion 15 of the light insignia encloses the bulb and wiring that is associated therewith. The Plug 14 extends from the Sports Insignia Light 10 and connects to the receptacle for the trailer hitch of the vehicle.

The Sports Insignia Light 10 may be mounted in any position in the rear of a vehicle and provides a means to illuminate a sports insignia associated with the user's favorite sports team. Although the sports insignia light is depicted as an oval-shaped light, the light may be modified in other shapes such as a rectangular, square, octagon or other available shapes that may be associated with the sports team of the user's choice. The Sports Insignia Light 10 illuminates when the driver depresses the brake and in conjunction with the brake lights.

The Sports Insignia Light 10 provides a means for the sports fan to demonstrate their loyalty to their favorite sports team and adorn their vehicle with sporting paraphernalia. The light is electrically powered through the wiring connection to the trailer hitch receptacle. A wide variety of teams may use this sporting light insignia as a means to demonstrate fan loyalty. The instant invention has been shown and described in what it considers to be the most practical and preferred embodiments. It is recognized, however, that departures may be made there from within the scope of the invention and that obvious modifications will occur to a person skilled in the art.

What is claimed is:

1. An illuminated sports insignia for a vehicle comprising:
a. a sports insignia;
b. a body portion, where said body portion is behind the sports insignia;
c. a bulb within the body portion; and
d. a plug extending from the body portion, where said plug provides a means to connect to a trailer hitch receptacle.

2. The illuminated sports insignia according to claim 1, where said insignia includes an oval shape.

3. The illuminated sports insignia according to claim 1, where the insignia includes at least one of a rectangular, a square and an octagon shape.

4. The illuminated sports insignia according to claim 1, where the illuminated insignia is synced with the brake lights of the vehicle.

5. The illuminated sports insignia according to claim 1, where the trailer receptacle provides power to the bulb and syncs the illumination of the bulb with the brake lights of the vehicle.
